(19) United States
(12) Patent Application Publication
(10) Pub. No.: US 2017/0106639 A1
(43) Pub. Date: Apr. 20, 2017

(54) METHODS AND SYSTEMS FOR THERMOFORMING TWO AND THREE WAY HEAT EXCHANGERS

(71) Applicant: 7AC Technologies, Inc., Beverly, MA (US)

(72) Inventors: Peter F. Vandermeulen, Newburyport, MA (US); Scott N. Rowe, Dover, NH (US); Richard Madigan, Beverly, MA (US); Mark D. Rosenblum, Woburn, MA (US)

(73) Assignee: 7AC Technologies, Inc., Beverly, MA (US)

(21) Appl. No.: 15/297,648

(22) Filed: Oct. 19, 2016

Related U.S. Application Data
(60) Provisional application No. 62/243,963, filed on Oct. 20, 2015.

(51) Int. Cl. B32B 37/06; B32B 37/15; F28F 9/007; F28D 21/00; F28F 3/10; B32B 38/00; F28F 13/12

(52) U.S. Cl. CPC B32B 37/06; B32B 38/0004; B32B 37/15; F28F 13/12; F28D 21/0015; F28F 3/10; F28F 9/0075; B32B 2307/30; F28F 2275/02; F28D 2021/0038; F28F 2230/00

(57) ABSTRACT

A method of manufacturing a heat exchanger, include the steps of: (a) providing two plates configured to be assembled together, each of the plates comprising a support layer and a cap layer laminated over the support layer at least at a front side of the plate; (b) heat bonding a microporous membrane layer to one or more select portions of the cap layer on the front side of each plate such that a liquid desiccant channel is formed between the membrane layer and the front side of each plate; and (c) attaching the front sides of the plates together to form a plate pair structure by heat bonding one or more select portions of the cap layers on the front sides of the plates such that the membrane layers on the plates face each other and an air flow channel is formed between the membrane layers.

### CROSS REFERENCE TO RELATED APPLICATION

This application claims priority from U.S. Provisional Patent Application No. 62/243,963filed on Oct. 20, 2015entitled METHODS AND SYSTEMS FOR THERMOFORMING TWO AND THREE WAY HEAT EXCHANGERS, which is hereby incorporated by reference.

### BACKGROUND

The present application relates generally to the use of liquid desiccants to dehumidify and cool an air stream entering a space. More specifically, the application relates to the use of micro-porous membranes mounted to (thermo-) formed polymer support structures to separate the liquid desiccant from the air stream wherein the fluid streams (air, cooling fluids, and liquid desiccants) are made to flow turbulently so that high heat and moisture transfer rates between the fluids can occur. The application further relates to corrosion resistant heat exchangers between two or three fluids. Such heat exchangers can use gravity induced pressures (siphoning) to keep the micro-porous membranes properly attached to the polymer support structures.

Liquid desiccants have been used in parallel to conventional vapor compression HVAC equipment to help reduce humidity in spaces, particularly in spaces that either require large amounts of outdoor air or that have large humidity loads inside the building space itself. Humid climates, such as for example Miami, Fla. require a large amount of energy to properly treat (dehumidify and cool) the fresh air that is required for a space's occupant comfort. Conventional vapor compression systems have only a limited ability to dehumidify and tend to overcool the air, oftentimes requiring energy intensive reheat systems, which significantly increase the overall energy costs because reheat adds an additional heat-load to the cooling coil. Liquid desiccant systems have been used for many years and are generally quite efficient at removing moisture from the air stream. However, liquid desiccant systems generally use concentrated salt solutions such as solutions of LiCl, LiBr or CaCl₂ and water. Such brines are strongly corrosive, even in small quantities so numerous attempt have been made over the years to prevent desiccant carry-over to the air stream that is to be treated. One approach—generally categorized as closed desiccant systems—is commonly used in equipment known as absorption chillers, places the brine in a vacuum vessel, which then contains the desiccant and since the air is not directly exposed to the desiccant. Such systems do not have any risk of carry-over of desiccant particles to the supply air stream. Absorption chillers however tend to be expensive both in terms of first cost and maintenance costs, in addition, in order to provide chilled air, numerous heat exchangers need to be provided between air streams and a heat transfer fluid that can be directed into coils mounted in the vacuum vessel. Open desiccant systems on the other hand allow a direct contact between the air stream and the desiccant, generally by flowing the desiccant over a packed bed similar to those used in cooling towers. Such packed bed systems suffer from other disadvantages besides still having a carry-over risk, including the high resistance of the packed bed to the air stream results in larger fan power and pressure drops across the packed bed, requiring thus more energy. Furthermore, the dehumidification process is adiabatic, since the heat of condensation that is released during the absorption of water vapor into the desiccant has no place to go. As a result both the desiccant and the air stream are heated by the release of the heat of condensation. This results in a warm, dry air stream where a cool dry air stream was desired, necessitating the need for a post-dehumidification cooling coil or for a cooling coil added to the packed bed in some fashion. Warmer desiccant is also exponentially less effective at absorbing water vapor, which forces the system to supply much larger quantities of desiccant to the packed bed, which in turn requires larger desiccant pump power, since the desiccant is doing double duty as a desiccant as well as a heat transfer fluid. These larger desiccant flooding rates also result in an increased risk of desiccant carryover. Generally air flow rates need to be kept well below the turbulent region (at Reynolds numbers of less than ˜2,400) to prevent carryover of liquid desiccant droplets to the air stream. Applying a micro-porous membrane to the surface of the liquid desiccant has several advantages. First, it inhibits desiccant from escaping (carrying-over) to the air stream and becoming a source of corrosion in the building. Second, the membrane allows for the use of turbulent air flows enhancing heat and moisture transfer, which in turn results in a smaller system since it can be build more compactly. The micro-porous membrane retains the desiccant typically by being hydrophobic to the desiccant solution. Breakthrough of desiccant can occur but only at desiccant pressures significantly higher (usually two to three orders of magnitude around 40-80 psia ) than the operating pressure (usually well less than two psia or sometimes negative to ambient at less than one psia). The water vapor in an air stream that is flowing over the membrane diffuses through the membrane into the underlying desiccant resulting in a drier air stream. If the desiccant is at the same time cooler than the air stream, a cooling function will occur as well, resulting in a simultaneous cooling and dehumidification effect.

U.S. Pat. No. 8,943,850 and PCT Application No. PCT/US11/037936 by Vandermeulen et al. disclose several embodiments for plate structures for membrane dehumidification of air streams. U.S. Patent Application Publication No. 2014-0150662 , PCT Application No. PCT/US13/045161, and U.S. Patent Application Nos. 61/658,205, 61/729,139, 61/731,227, 61/736,213, 61/758,035 and 61/789,357 by Vandermeulen et. al disclose several manufacturing methods and details for manufacturing membrane desiccant plates. Each of these patent applications is hereby incorporated by reference herein in its entirety.

Membrane modules often suffer from problems wherein glue or adhesion layers are stressed by temperature differences across the various components. This is particularly difficult in components that are operating under high temperatures such as liquid desiccant regenerators. In order to inhibit cracking and warping of the plastics or failures of the bonds or adhesives, a 2- or 3- layer plate structure is disclosed that has a thin first and or second outer layer made from a easily meltable plastic (such as, e.g., PE (Poly Ethylene)) and a thicker central layer made from a more rigid material (such as, e.g., ABS (Acrylonitrile Butadiene Styrene), PVC (Poly Vinyl Chloride), or Acrylic). Additional support structures are made from similar inexpensive rigid materials and the thin outer layer on the first structure functions as an adhesion layer to the other support structures. One advantage of this structure is that the materials have very similar if not identical expansion coefficients, while still providing for fluid passages and other features such as edge seals for air passages and turbulating features for those same air passages.

Membrane modules often suffer from problems wherein glue or adhesion layers are stressed by temperature differences across the various components. This is particularly difficult in components used for the regeneration of the desiccant, since many common plastics have high thermal expansion coefficients. Oftentimes specialty high-temperature plastics such as polysulfones are employed that are expensive to use in manufacturing. Bonding large surface areas together also creates problems with the adhesion and can cause stress fractures over time. Potting techniques (typically a liquid poured epoxy thermoset plastic) have some resilience if the potting material remains somewhat compliant even after curing. However the systems and methods described herein are significantly more resistant to expansion caused by high temperatures, which keeping the manufacturing process simple and robust.

Furthermore, a problem when building conditioner and regenerator systems for 2-way liquid desiccants is that it is hard to design a system that provides uniform desiccant distribution on both sides of a thin sheet of plastic support material. The systems and methods described herein show a simple method for exposing an air stream to a series of membranes covering the desiccant.

There thus remains a need for a system that provides a cost efficient, manufacturable and thermally efficient method to capture moisture from an air stream, while simultaneously cooling such an air stream and while also eliminating the risk of contaminating such an air stream with liquid desiccant particles.

Heat exchangers (mostly for two fluids) are very commonly used in many applications for heat transfer and energy recovery. Most heat exchangers are constructed out of metals such as copper, stainless steel and aluminum. Generally speaking such heat exchangers incorporate features that attempt at disturbing the fluid flows in order to enhance the heat transfer between the fluid and the metal surfaces. Fluidic boundary layers near the surface of the metals create larger resistances to heat transfer. In quite a few applications, one or both of the fluids can be corrosive to the commonly used metals. Surface coatings can help prevent corrosion, but tend to also have decreased heat transfer coefficients. Metals that are not sensitive to corrosion such as Titanium, are generally considered expensive to use and difficult to work with. Plastics can be used but they oftentimes cannot withstand the operating pressures and temperatures that are typically used for the fluids. There thus remains a need for a cost-effective, corrosion resistant liquid to liquid heat exchanger.

### SUMMARY

In accordance with one or more embodiments, methods and systems are disclosed for extruding a cap layer onto a carrier material for the purpose of heat bonding other components to the cap layer at a later stage. In some embodiments the cap layer is an easily meltable plastic material such as Poly Ethylene (PE), Poly Propylene (PP) or similar material. In some embodiments the carrier material is a common plastic material like (Recycled) Poly Ethylene Terephthalate ((R)PET), (High Impact) Poly Styrene ((HI)PS), Acrylonitrile Butadiene Styrene (ABS), Poly Carbonate (PC), Poly Vinyl Chloride (PVC) or other suitable plastic. In some embodiments the cap layer is attached on both sides of the carrier material. In some embodiments the thus formed carrier material is bonded to other pieces of the same carrier material. In some embodiments the thus formed carrier material is bonded to films made from the same or similar materials as the cap layer. In some embodiments the bonding process involves the application of pressure, heat, ultrasound, microwaves, radio frequency waves or combinations thereof or other convenient bonding processes.

In accordance with one or more embodiments, methods and systems are disclosed for thermally forming and die-cutting a thus created carrier material into a plate structure containing liquid turbulating features and edges for containing liquids as well as inlet and outlet ports for liquids. In some embodiments, a film material is die-cut into pieces in a parallel process. In some embodiments, the film material is made from a material similar to the cap layer of the carrier material. In some embodiments, the film material is die-cut into circular or ring-like shapes. In some embodiments, the ring-like shapes are thermally bonded to the main carrier material around the liquid ports. In some embodiments, the thus formed carrier material and ring assemblies are subsequently thermally bonded to other parts made in the same fashion to form a plate pair structure. In some embodiments, the ring materials from different plate pair assemblies touch and are subsequently bonded to form a ring to ring seal connection that is impervious to leaks. In some embodiments, the ring to ring seal connection is obtained by touching a hot wire element or tool against the edges of the rings from the different plate pairs. In some embodiments, the plate pairs are stacked to form a multi-plate pair structure. In some embodiments, such a stack of plate pairs is assembled into a housing to form a liquid to liquid heat exchanger.

In accordance with one or more embodiments, methods and systems are disclosed for thermally forming and die-cutting a carrier material containing one or two cap layers into a main carrier plate. In some embodiments the carrier plate contains desiccant and heat transfer fluid inlet, outlet and distribution features which are formed in the plate to ensure that desiccant and heat transfer fluids are evenly distributed along the surface of the plate and amongst several similar plates attached in later process steps. In some embodiments the distribution features contain outlet resistance channels meant to induce a certain amount of back pressure in the outlets to ensure even flow rates between multiple outlet holes in the support plate. In some embodiments the outlet resistance channels allow the desiccant to flow into a distribution structure of horizontal lines and dots that are designed to distribute the desiccant evenly and to slow down the desiccant flow rate. In some embodiments the carrier plate contains formed ridges designed to form a portion of an air channel. In some embodiments the carrier plate contains other ridges designed to form a liquid seal between two carrier plates when those two plates are bonded together. In some embodiments multiple liquids can so be directed to several areas on the front and rear surfaces of the carrier plates. In some embodiments the carrier plate is cooled or heated on the opposite side by a heat transfer fluid. In some embodiments the heat transfer fluid is water or a water/glycol mixture. In some embodiments the heat transfer fluid is running through a plastic mesh wherein the plastic mesh sets the distance between the support plate and a second carrier plate and wherein the heat transfer fluid is made to become turbulent by the mesh. In some embodiments, the mesh is a dual plane diamond plastic mesh. In some embodiments, the diamond mesh comprises a co-extruded plastic and an adhesive. In some embodiments, the diamond mesh is coated with an adhesive in a separate process step. In some embodiments a film seal material is die-cut into pieces that are to become part of a liquid distribution system. In some embodiments the film seal is made from a material similar to the cap layer of the carrier plate. In some embodiments the film seal material is made from Poly Ethylene or Poly Propylene. In some embodiments the film seal material is partially covered by an anti-stick coating or layer. In some embodiments the coating or layer is a Teflon™ or other non-stick tape material.

Systems and methods are provided wherein the carrier plate assemblies described in the previous section are connected by thermally bonding two carrier plates together thereby forming an air or liquid channel. In some embodiments, the carrier plates each have a membrane attached to their front sides (facing the air gap). In some embodiments an air turbulator is added to the air channel while the two carrier plates are bonded together. In some embodiments the air turbulator is another thermoformed or injection molded plate using similar plastics as the carrier plates. In some embodiments the air turbulator thermoforming process also yields support parts for the liquid desiccant channel which can be used during the assembly process.

Systems and methods are provided wherein a film seal material is first heat bonded to the back-side of a main carrier plate. In some embodiments a membrane is subsequently attached to the front (air facing) side of the carrier plate using heat, pressure, RF or microwave radiation or a combination thereof. In some embodiments two carrier plates with film seals and membranes thus attached, are assembled with the membranes facing each other wherein an air turbulator is added to create enhanced heat and mass transfer through the membrane between the two carrier plates. In some embodiments the corners of the carrier plates are now bonded together creating a plate pair with an air turbulator positioned in-between. In some embodiments the corner seal contains a foam seal component. In some embodiments the foam comprises a poly urethane foam. In some embodiments the air turbulator is held in place by air seals. In some embodiments the air seals are made from a foam material such as a poly urethane foam. In some embodiments the air seal and the corner seal are made from a single foam seal component.

In some embodiments a film seal support structure is now added underneath the film seal and between the carrier plates to ensure that the film seal stays open for the passage of a liquid desiccant fluid. In some embodiments a heat transfer fluid turbulating component is added on the rear of the main carrier plates. In some embodiments the heat transfer fluid is running through a plastic mesh component wherein the plastic mesh sets the distance between the support plate and a second carrier plate and wherein the heat transfer fluid is made to become turbulent by the mesh. In some embodiments, the mesh is a dual plane diamond plastic mesh. In some embodiments, the diamond mesh comprises a co-extruded plastic and an adhesive. In some embodiments, the diamond mesh is coated with an adhesive in a separate process step. In some embodiments the two carrier plates around the heat transfer liquid turbulating component are subsequently sealed together to form a liquid tight seal. In some embodiments the film seals are lastly sealed together to provide the final seal for the liquid desiccant.

Systems and methods are provided wherein a carrier material with a single cap layer is thermoformed and die cut to form a main carrier plate and separate desiccant distribution- and collection components of an air to liquid desiccant to heat transfer fluid heat exchanger. In some embodiments the cap layer is an easily meltable plastic material such as Poly Ethylene (PE), Poly Propylene (PP) or similar material. In some embodiments the carrier material is a common plastic material like (Recycled) Poly Ethylene Terephthalate ((R)PET), (High Impact) Poly Styrene ((HI)PS), Acrylonitrile Butadiene Styrene (ABS), Poly Carbonate (PC), Poly Vinyl Chloride (PVC) or other suitable plastic. In some embodiments the desiccant distribution and collection components are designed to be placed interlockably on the main carrier plate. In some embodiments the interlockable functionality is achieved by designing a small number of protrusions and receptacles in the main carrier plate or components. In some embodiments, in a parallel process to the above, a seal film is die-cut to provide a number of seal film components. In some embodiments the seal film comprises a material that can easily be melted and bonded to the cap layer on the main carrier plate. In some embodiments the seal film material is a Poly Ethylene or Poly Propylene material.

In some embodiments an air and/or a water turbulator are thermoformed to be used as a means to enhance heat and mass transfer between an air stream and a membrane or a heat transfer fluid and a carrier plate material respectively. In some embodiments the air and water turbulator material is a common plastic material like (Recycled) Poly Ethylene Terephthalate ((R)PET), (High Impact) Poly Styrene ((HI)PS), Acrylonitrile Butadiene Styrene (ABS), Poly Carbonate (PC), Poly Vinyl Chloride (PVC) or other suitable plastic. In some embodiments the water turbulator is coated with an adhesive in a separate process step. In some embodiments the adhesive is a hot melt adhesive. In some embodiments the adhesive is a poly urethane or other suitable adhesive.

Systems and methods are provided wherein the film seals described above are first thermally bonded to the main carrier plate. In some embodiments the bonding is accomplished with heat, pressure, radio frequency heating, microwave heating or a combination thereof. In some embodiments the desiccant distribution and collection components are bonded to a membrane at such a distance from each other that the components can later be lockably placed in the main carrier plate. In some embodiments the membrane is bonded using heat, pressure, radio frequency heating, microwave heating or a combination thereof. In some embodiments the membrane with the attached desiccant distribution and collection components is now locked and placed inside the appropriate features of the main carrier plate. In some embodiments the remainder of the membrane is now attached to the main carrier plate. In some embodiments the membrane is bonded using heat, pressure, radio frequency heating, microwave heating or a combination thereof. In some embodiments several of the thus described carrier plate with membranes and desiccant distribution and collection components are produced. In some embodiments two of such assemblies receive a water turbulator as described above which is bonded to the rear of the plates. In some embodiments the desiccant distribution and collection components are then temporarily unlocked and hinged out of the way so as to provide access for a sealing tool that creates a main heat transfer fluid seal as well as two desiccant area seals: one around the desiccant distribution area and one around the desiccant collection area. In some embodiments the desiccant distribution and collection components are then re-locked into place and a final seal at the edges of the membrane is created using heat, pressure, radio frequency heating, microwave heating or a combination thereof. In some embodiments the thus created plate pairs are stacked together with air turbulators there between. In some embodiments the film seals are finally bonded together using a source of heat such as a hot wire or hot tool. In some embodiments the film seals is bonded using heat, pressure, radio frequency heating, microwave heating or a combination thereof.

In no way is the description of the applications intended to limit the disclosure to these applications. Many construction variations can be envisioned to combine the various elements mentioned above each with its own advantages and disadvantages. The present disclosure in no way is limited to a particular set or combination of such elements.

### BRIEF DESCRIPTION OF THE FIGURES

FIG. 1A and 1B depict a thermoformed 3 way membrane plate construction wherein turbulating features for heat transfer fluid and desiccant distribution are formed directly into each structure.

FIG. 2 shows a thermoformed 3 way membrane plate construction wherein the water or heat transfer fluid channel is formed with a polyurethane component or similar bonding material.

FIG. 3 shows a liquid to liquid heat exchanger wherein water turbulating features are formed into each plate and wherein plate pairs are bonded together by a poly urethane or similar bonding material.

FIG. 4 illustrates an exemplary and simplified process flow for creating a liquid to liquid heat exchanger without using a polyurethane or similar bonding material in accordance with one or more embodiments.

FIG. 5 illustrates an extrusion process for making a multilayer structural plate with a thin cap-layer on either or both sides in accordance with one or more embodiments.

FIG. 6 illustrates a thermoforming or bonding process wherein a multilayer carrier and seal film are prepared in accordance with one or more embodiments.

FIG. 7 shows the assembly steps for the components of FIG. 6 in accordance with one or more embodiments.

FIG. 8 shows the assembly steps of two structures from FIG. 7 being assembled into a plate pair structure in accordance with one or more embodiments.

FIG. 9 shows how the plate pairs from FIG. 8 are bonded into a stack of plate pairs in accordance with one or more embodiments.

FIG. 10A illustrates the bonding of a number of film seal components to the thermoformed base plates in a 3D view in accordance with one or more embodiments.

FIG. 10B illustrates the bonding of one plate pairs to another plate pair in accordance with one or more embodiments.

FIG. 11 illustrates and exemplary and simplified process flow for creating a 3-way liquid desiccant to fluid to air heat exchanger without using a poly urethane or similar bonding material in accordance with one or more embodiments.

FIG. 12A shows four parallel processes to prepare components for the 3-way heat exchanger assembly in accordance with one or more embodiments.

FIG. 12B shows a process flow to assemble the components from FIG. 12A for assembly into a 3-way heat exchanger module in accordance with one or more embodiments.

FIG. 13 illustrates the full 3 dimensional view of the assembly of a plate pair of a 3-way air to desiccant to liquid heat exchanger in accordance with one or more embodiments.

FIG. 14A shows the process details of heat bonding the film seal to the base plate in accordance with one or more embodiments.

FIG. 14B shows tooling for bonding the film-seal to the base plate in accordance with one or more embodiments.

FIG. 15A illustrates the heat sealing of the plate pairs by using a non-stick area in accordance with one or more embodiments.

FIG. 15B shows a detail of the process of heat sealing the plate corners in accordance with one or more embodiments.

FIG. 16 shows the stacking of plate pairs into a multi-pair assembly in accordance with one or more embodiments.

FIG. 17A illustrates the seal to seal sealing of the plate pairs by using a hot tool to bond the layers in accordance with one or more embodiments.

FIG. 17B shows a detail of the process of film to film sealing of the components created in FIG. 17A in accordance with one or more embodiments.

FIG. 18A illustrates an alternate set of components to be used for assembling a three-way air to desiccant to heat transfer fluid heat exchanger in accordance with one or more embodiments.

FIG. 18B shows the assembly steps for assembling the components created in FIG. 18A in accordance with one or more embodiments.

### DETAILED DESCRIPTION

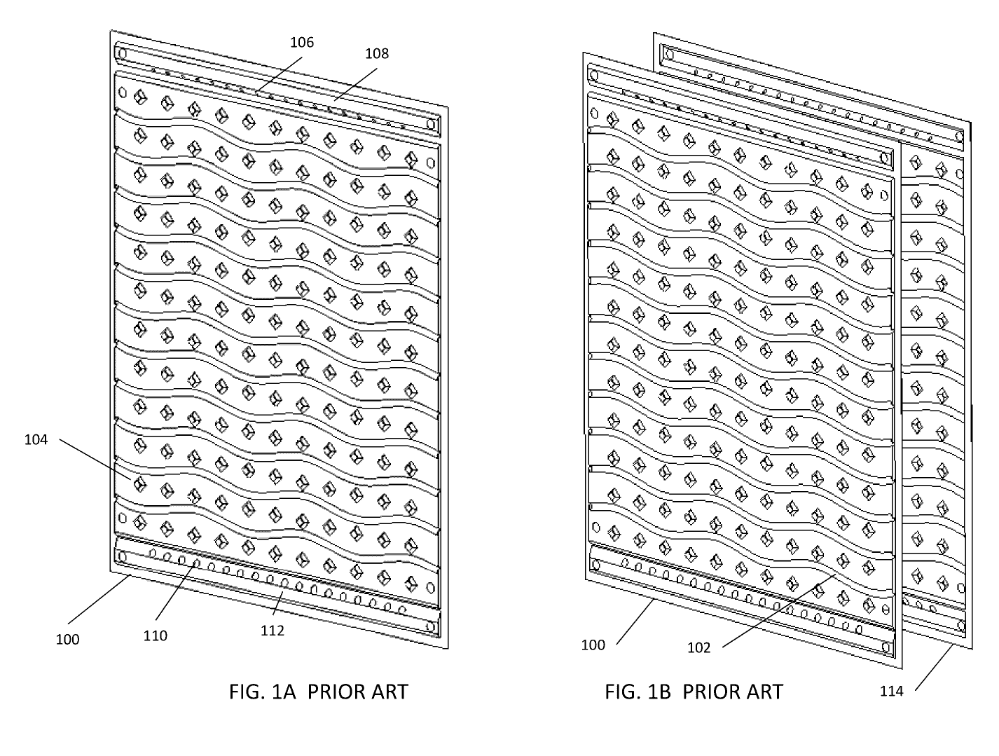

FIGS. 1A and 1B illustrate a support plate structure as disclosed in U.S. Patent Application Publication No. US 2014-0150662, wherein the support plate 100, water channel features 102 and desiccant distribution features 104 have been (thermo-) formed into the support plate structure itself, as well as desiccant inlet features 106 and 108 and desiccant drain features 110 and 112. Two identical plates 100 and 114 can be heat bonded together to form a membrane plate pair structure and multiple membrane plate structures can be joined with the seal structures into a membrane module.

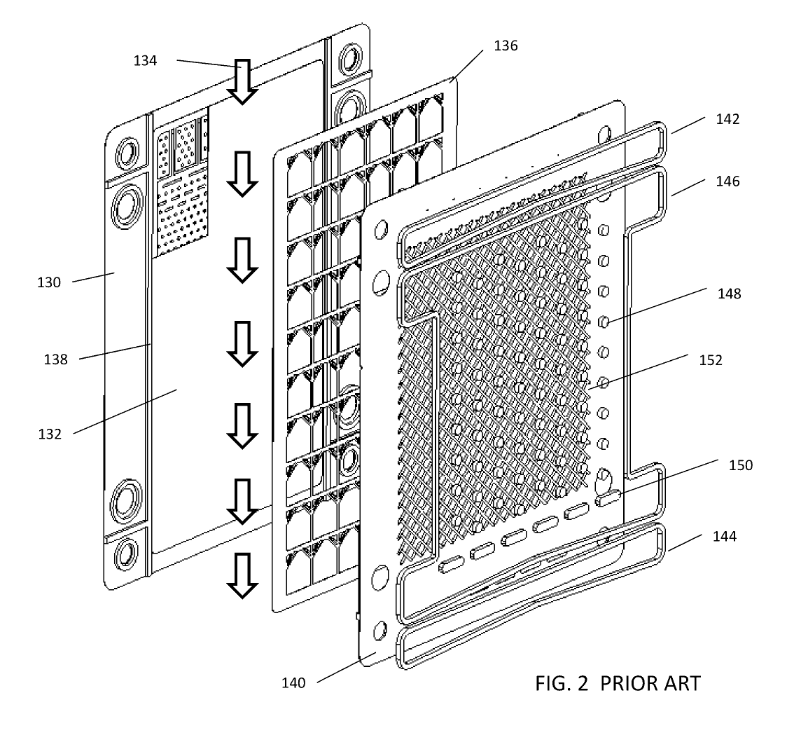

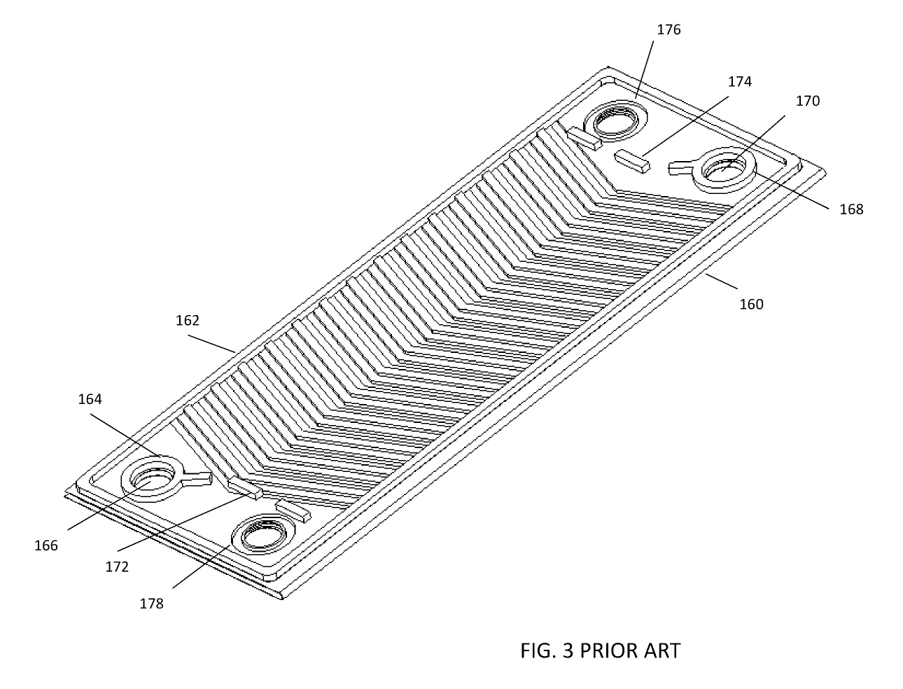

FIG. 2 shows an “exploded” view of a complete 2-plate structure as disclosed in U.S. Patent Application Publication No. 2015-0300754 . A first thermoformed plate 130 has a membrane 132 attached, a corner of which has been removed for purposes of illustration to show the upper left corner of one of the plates 130. A vertical air flow 134 is directed downward over the surface of the membrane 132. An air turbulator 136 is then adhesive or preferably heat bonded to the air channel edges 138. A second plate 130 is bonded to the air turbulator 136 at the same time. A gluing robot then applies desiccant reservoir lines 142 and 144 and water channel reservoir lines 146, adhesive dots 148 and obstructions 150 used to create uniform liquid flow. A water net 152 can be added or water net features could be integrated to the rear of the plates 140 as discussed in the application.

FIG. 3 now shows how a folded plate 160 (from U.S. Patent Application Publication No. 2015-0300754 ) is sealed by an adhesive seal 162 around the second liquid channel. An adhesive seal 164 is used around the outlet port 166 and an additional seal 168 is used around port 170. Additional distribution obstructions 172 and 174 can be used to ensure even liquid flows across the plates. No seal will be needed around the ports 176 and 178 since the heat bonding process already accomplished this seal. The structure of FIG. 3 can now be stacked multiple times to form an inexpensive plastic plate heat exchanger for low pressure and low flow liquids with plastics that are insensitive to the corrosive liquid desiccants used in liquid desiccant systems.

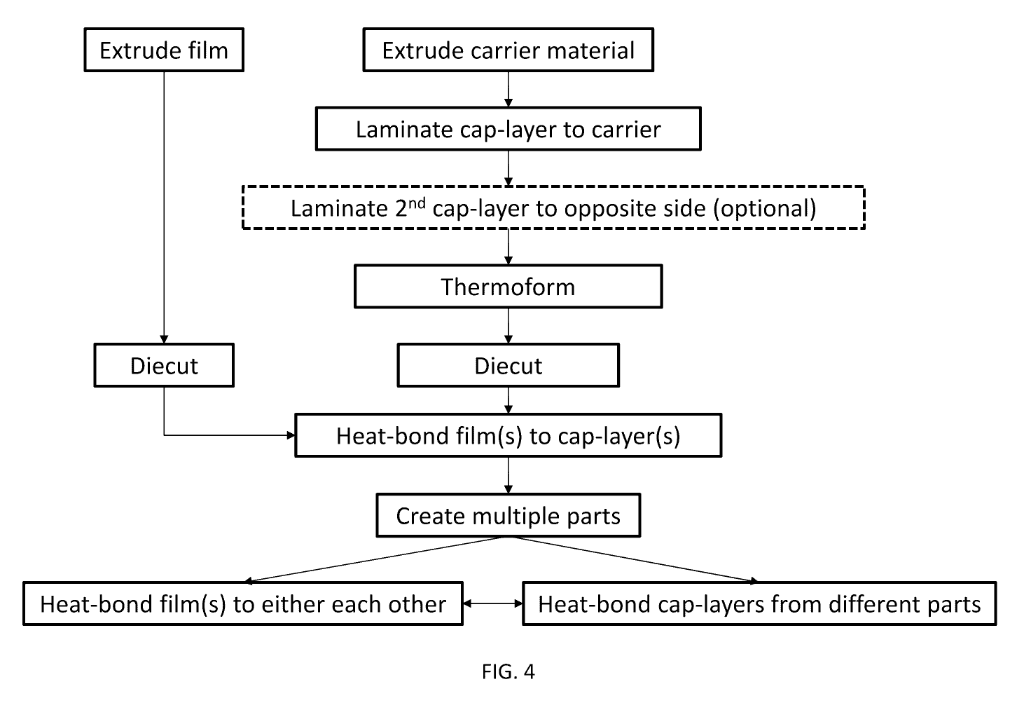

FIG. 4 illustrates the process steps for an alternative plate structure assembly for a liquid to liquid heat exchanger that has the advantage that no polyurethane or similar adhesive layers will be needed, thereby leading to a significantly reduced process complexity and cost. In the figure, an extruded carrier material (usually a common plastic material like (Recycled) Poly Ethylene Terephthalate ((R)PET), (High Impact) Poly Styrene ((HI)PS), Acrylonitrile Butadiene Styrene (ABS), Poly Carbonate (PC), Acrylic or other suitable plastic) and usually 10-15 mil (0.25 to 0.4mm) is laminated to a very thin film seal (cap-) layer material, usually a poly propylene (PP) or poly ethylene (PE) in a thickness of 1-3 mil (0.025-0.075 mm). Optionally a second cap-layer is similarly bonded to the opposite side of the main carrier plate material usually of the same or similar material as the first cap-layer.

The so extruded and laminated base material structure is now formed by common thermoforming equipment, after which it is die-cut into individual parts. In parallel a second film is obtained by extrusion, said second film usually made from the same material as the cap-layer(s). The second film is now also die cut into individual parts. The main carrier plate parts and film parts can now easily be heat bonded together, because the cap-layer(s) and the films are the same plastic or at least compatible plastics and therefore bond together easily with heat and pressure. Multiple assemblies of heat bonded parts can now also be bonded to each other to form stacks of parts by either bonding cap-layers from main parts to cap-layers from other main parts, or bonding cap-layers to film parts or binding film parts to film parts.

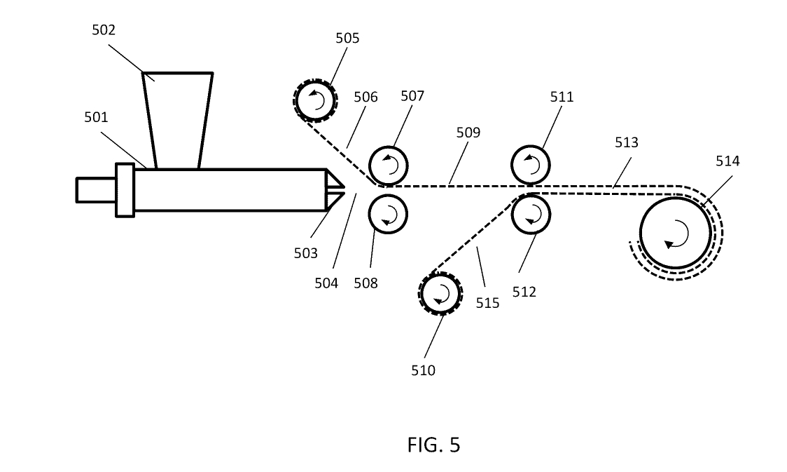

FIG. 5 illustrates a process of extruding the main carrier while bonding two cap-layers to the main carrier material. An extrusions screw system 501 is fed plastic resin pellet through a hopper 502. The thus heated and molten resin is extruded through a die 503 into a single film 504. A set of rollers 507 and 508 pick up the extruded film 504 as well as a thin cap-layer film 506 that is unwound from a storage roll 505 which was prepared in a separate process, not shown. The rolls 507 and 508 apply pressure and heat to form a material with a single cap-layer 509. A second set of rollers 511 and 512 take up the incoming material 509 and a second cap-layer film 515 from a second storage roll 510. The second pair of rollers 511 and 512 also apply pressure and heat resulting in a double cap-layer on the base extruded material 513, which is taken up by an output roll 514. There are of course multiple variations possible for this basic process, all fundamentally resulting in a base carrier material with either a single or dual cap-layer.

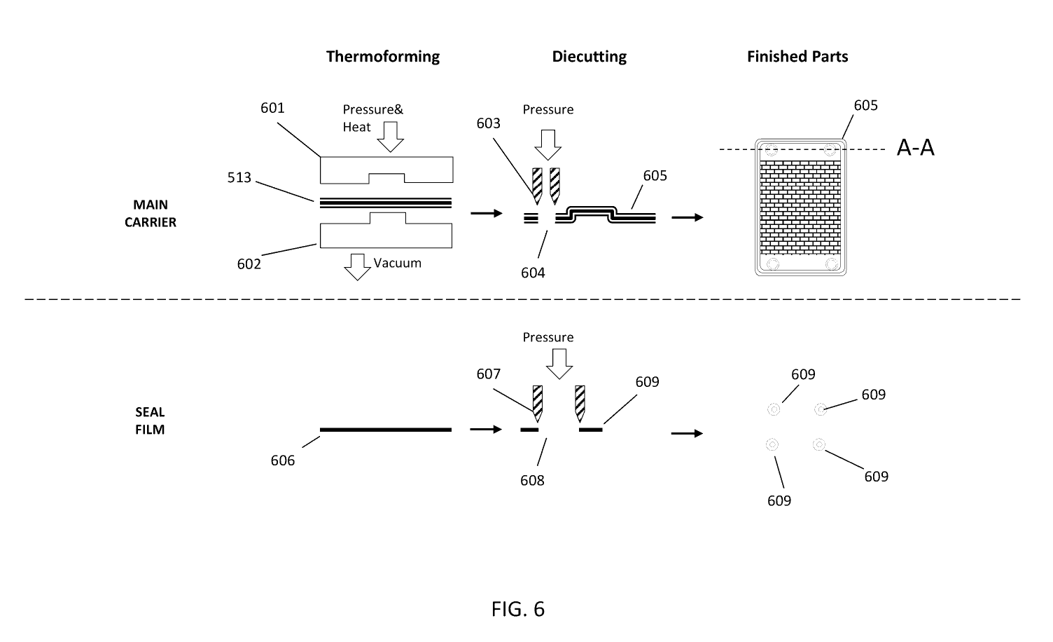

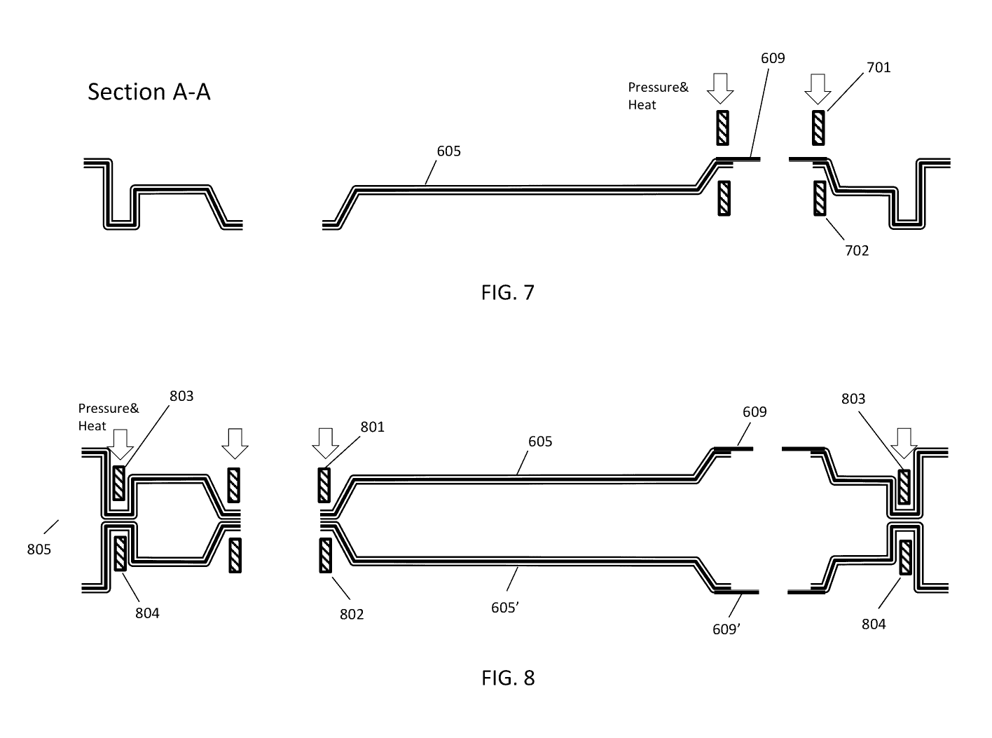

In FIG. 6 the material 513 from FIG. 5 is now entered into a common thermoforming system where an upper mold 601 and lower mold 602 are used with heat and pressure and often with a vacuum assist to form shapes into the material 513. The thus shaped material is now fed into a diecutting system (which is usually integral to the thermoforming machine) where holes 604 and other features are cut by a die 603 under pressure, resulting into a final part 605 with the desired features and shapes. Cross-section A-A will be discussed in FIG. 7. Similarly, in the lower half of the figure, a seal film 606 is die-cut by a different die 607 creating features 608 and resulting in film parts 609.

FIG. 7 illustrates the cross section A-A of FIG. 6. As can be seen in the figure, the main carrier 605 receives a film seal part 609 which is bonded by heat and pressure through tools 701 and 702. Since the film seal 609 and the cap-layer on the main carrier 605 are the same material, or very similar materials, this bond is easily made. At times, as is commonly done in the industry, some use of RF heating or microwave heating can be used to assist in bonding the main carrier 605 and the film seal 609, but often heat and pressure alone will suffice.

FIG. 8 now illustrates how two of the plates from FIG. 7 are bonded together to form a plate pair, again using heat and pressure and using tooling 801 and 802 around to seal the two main carrier plates 605 and 605′ around the hole in the plate and tooling 803 and 804 is also used to make an edge seal, again between the two carrier plates 605 and 605′ resulting in a single plate pair 805.

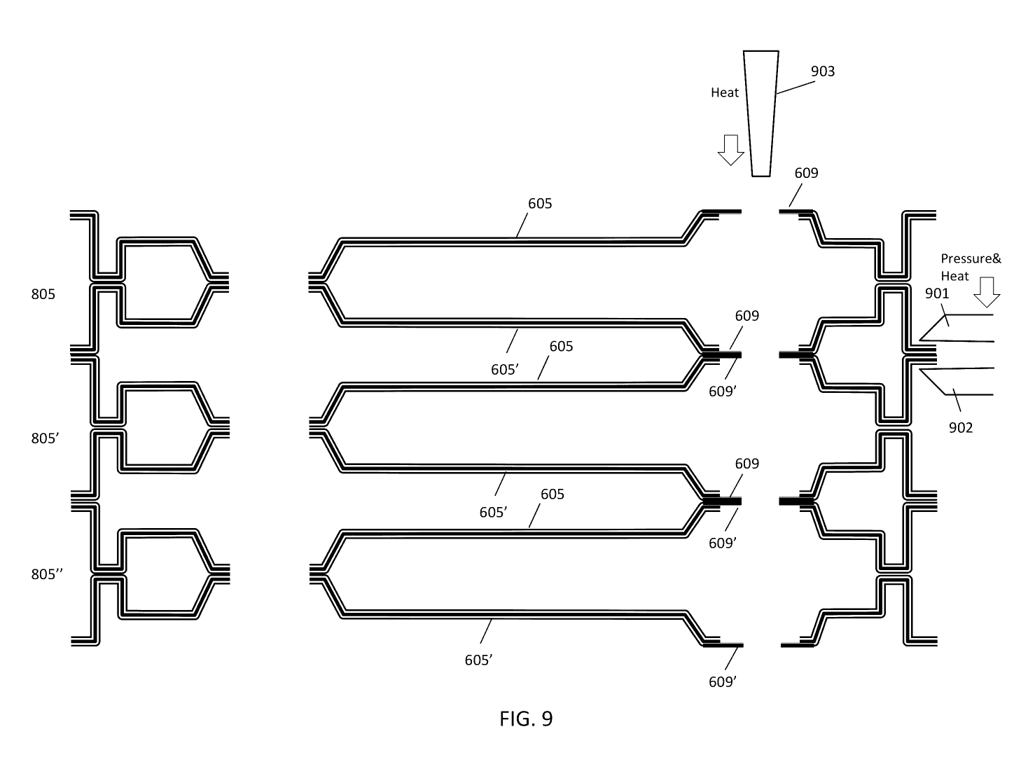

FIG. 9 shows how three pairs 805, 805′ and 805″ of plates from FIG. 8 are bonded together using heated perimeter clamps 901 and 902 providing a peripheral bond between plate pairs. For clarity only one bond location is shown in the cross section, but of course all plate-pairs are bonded similarly. However a bond still needs to be created between the seal film 609 from the first plate pair 805 and the film 609′ from the second plate pair 805′. This is accomplished by using a heated tool 903 and pushing it through the seal films 609 and 609′ resulting in properly bonded seals with an edge-sealed opening in the center where tool 609 went through. One can continue to stack plate pairs together (the figure shows three plate pairs 805, 805′ and 805″) so that a large assemble of plate pairs is obtained resulting in the desired liquid to liquid heat exchanger structure.

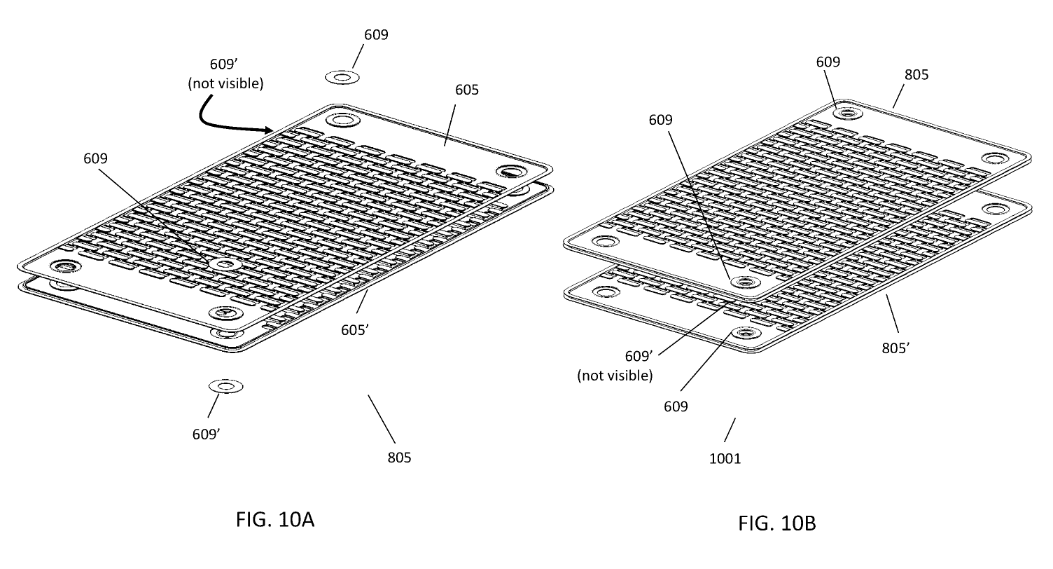

FIG. 10A illustrates the above described process in more detail: in the exploded view two carrier plates 605 and 605′ are shown. The two film seals 609 are both bonded to the carrier plate 605 and the two film seals 609′ are bonded to the carrier plate 605′.

FIG. 10B illustrates how the resulting plate pair of FIG. 10A is subsequently bonded to form the two carrier plate pairs 805 and 805′ which are bonded together into a double plate stack 1001 by bonding the edges together and by sealing the films 609 and 609′ together.

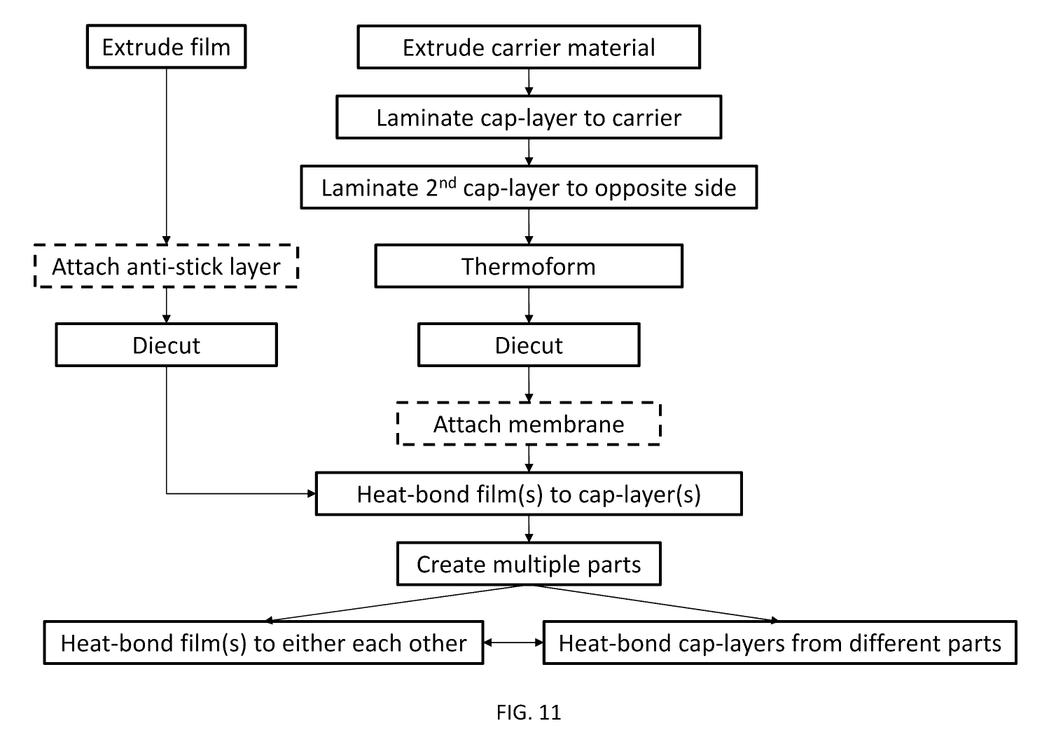

FIG. 11 illustrates a similar process to that of FIG. 4 for creating the parts of a three-way heat exchanger. The main carrier material is similar to FIG. 4 created by laminating two cap-layers to an extruded carrier. Again the main carrier material is thermoformed and die-cut into the appropriate shapes and parts. However, at this step a membrane is attached to the carrier material. Common membrane materials are Celgard EZ9020 membrane made by Celgard LLC, 13800 South Lakes Drive, Charlotte, S.C. 28273, which is primarily a Poly Propylene material or Solupor® 3P07A and similar variations thereof, manufactured by Lydall Solutech B.V. Eisterweg 4, 6422 PN Heerlen, The Netherlands, which is primarily a Poly Ethylene material. Either one of these two membranes will heat bond well to a Poly Ethylene cap-layer and conceivably equally well to a Poly Propylene cap-layer.

The parallel flow process for the extruded seal film is similar to the extruded seal film process flow in FIG. 4 with the exception that in some cases an anti-stick layer is needed in places of the film to prevent sticking of certain areas on parts during a heat-bonding process step. An anti-stick layer can be made by bonding a Teflon® or Kapton® tape (both materials trademarks of DuPont Corp., 1007 Market Street, Wilmington, Del.) to the area where the anti-stick function is desired. Similar to FIG. 4 it is now again possible to create multiple parts and heat-bond them together, as will be described below.

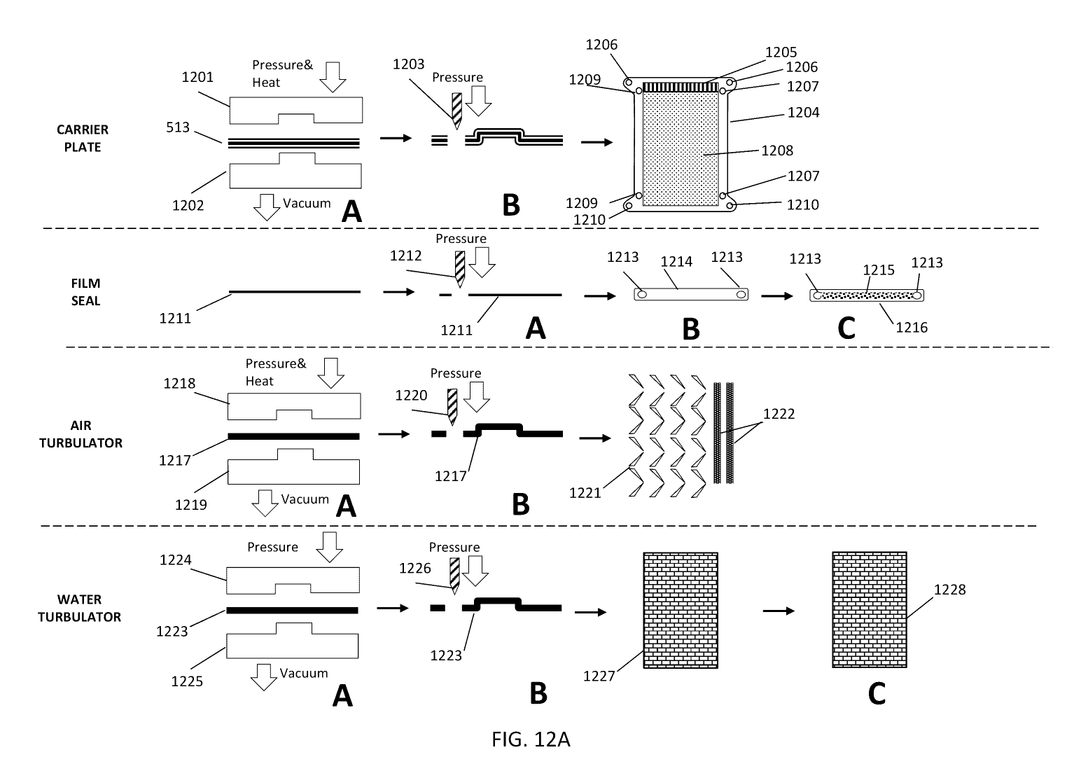

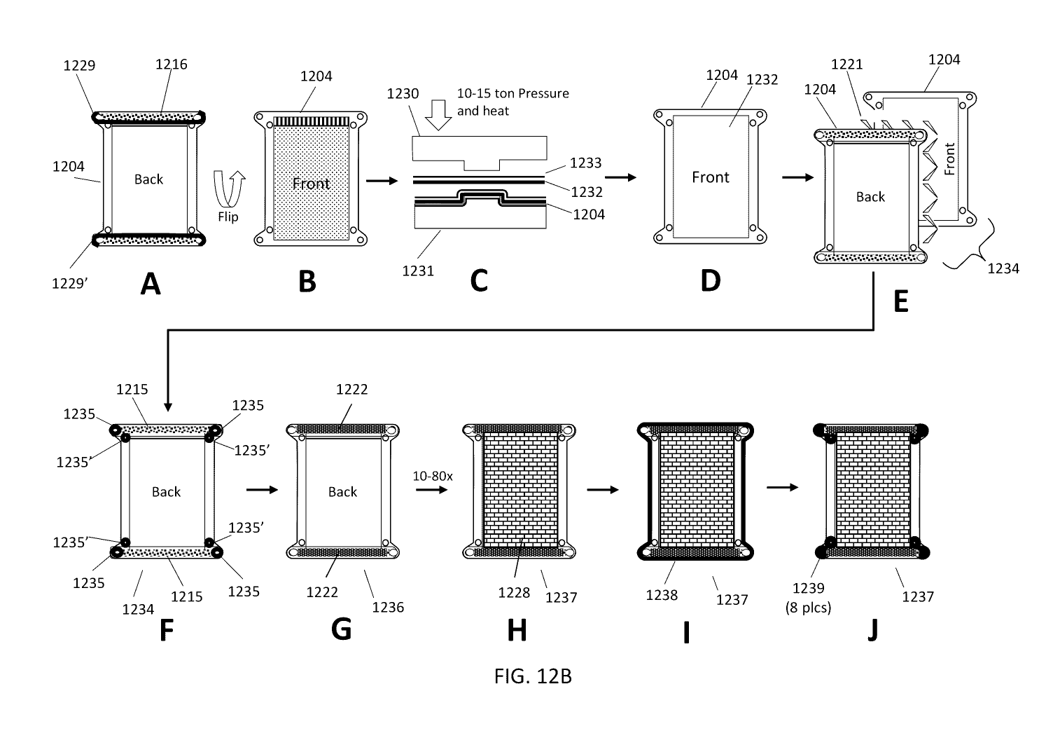

In FIG. 12A the process of forming the 3-way heat exchanger parts is shown. The main carrier plate is formed (in step “A”) similar to FIG. 6 by feeding starting material 513 (from FIG. 5) into a thermoforming system with mold parts 1201 and 1203. As before, the resulting part is die-cut (in step “B”) by tooling 1203 resulting in the base carrier plate 1204. The main features of carrier 1204 are the desiccant distribution area 1205, the desiccant inlet ports 1206, the heat transfer fluid supply ports 1207 and drain ports 1209, the desiccant distribution surface 1208 and the desiccant inlet ports 1206 and drain ports 1210. U.S. Patent Application Publication No. 2015-0300754 describes these features in more detail.

In parallel to the main carrier plate, a film seal material 1211 is die-cut by tool 1212 (in step “A”) resulting in a film part 1214 with two holes 1213 in step “B”. A non-stick material such as Teflon® or Kapton® tape is applied in step “C” on one side of the material leaving a non-stick area 1215 between the two holes 1213. The final part 1216 is stored for later use as will be shown in FIG. 12B.

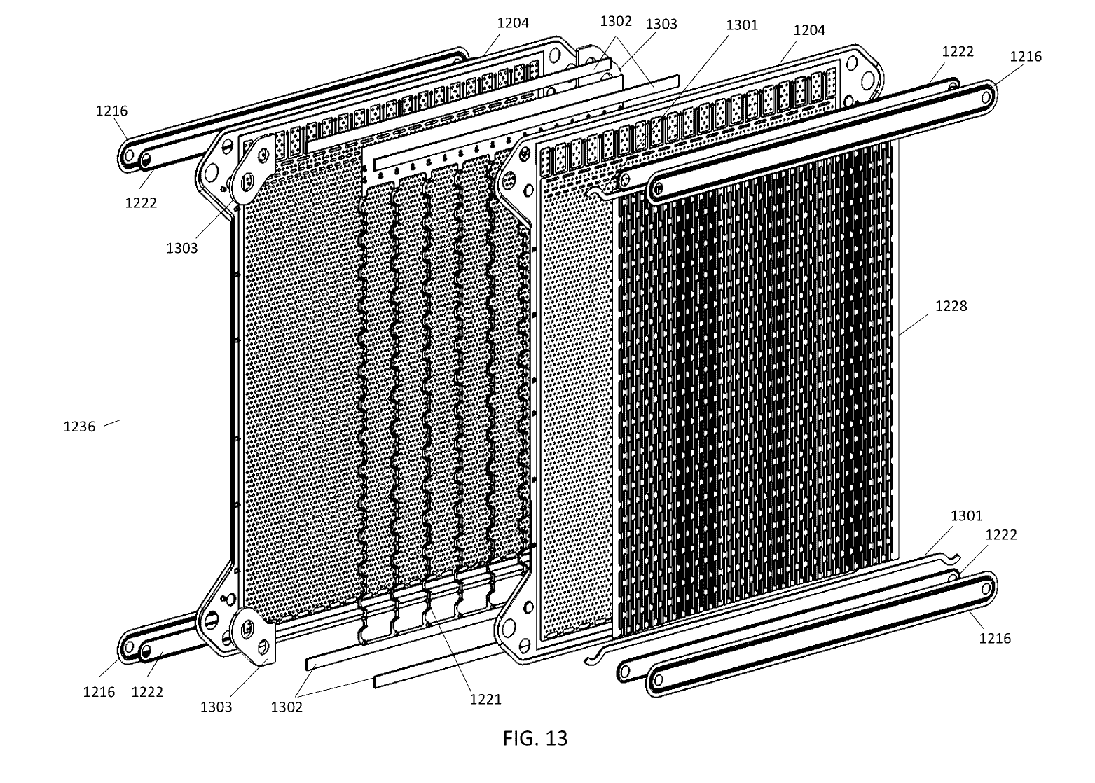

In parallel to the above flows, a third material 1217, which can be made from a number of different plastics such as (Recycled) Poly Ethylene Terephthalate ((R)PET), (High Impact) Poly Styrene ((HI)PS), Acrylonitrile Butadiene Styrene (ABS), Poly Carbonate (PC), Acrylic or other suitable plastic) and usually 5-15 mil (0.125 to 0.4 mm), and is thermoformed and die-cut into a shape for use as an air-turbulator. Tooling 1218 and 1219 form the parts' shape in step “A” and die-cut tool 1220 provides the necessary openings in step “B”. It is of course possible to cut different parts with one set of tooling as is shown in the figure, wherein the air turbulator 1221 is formed simultaneously with desiccant film seal supports 1222, who's function will be explained under FIG. 12B and FIG. 13.

In addition to the parts described above, the 3-way heat exchanger also benefits from using a water turbulator, which again can be made from a number of different plastics such as (Recycled) Poly Ethylene Terephthalate ((R)PET), (High Impact) Poly Styrene ((HI)PS), Acrylonitrile Butadiene Styrene (ABS), Poly Carbonate (PC), Acrylic or other suitable plastic) and usually 5-15 mil (0.125 to 0.4 mm), and is thermoformed and die-cut into a shape for use as an water-turbulator. Tooling 1224 and 1225 form the parts' shape in step “A” and die-cut tool 1226 provides the necessary openings in step “B”. The resulting water-turbulator part 1227 can be subsequently coated in step “C” with a hot melt layer or similar adhesive which could also be applied later during the assembly process shown in FIG. 12B step “H”.

FIG. 12B illustrates how the parts from FIG. 12A are assembled into a full 3-way air to liquid desiccant to heat transfer fluid heat exchanger. In step “A”, the thermoformed main carrier plate 1204 receives two film seals 1216 which are bonded with a heat-sealing tool along patterns 1229 and 1229′. In step “B” the plate 1204 is flipped over (now with the two film seals 1216 on the backside) and is fed into a press system consisting of male tool 1230 and female tool 1231 together with a membrane 1232 and a release sheet 1233. Female tool 1231 is designed to accept and support the part 1204 in such a way that when the press closes and pressure is applied in step “C”, the part 1204 is not deformed. The press applies heat and pressure and can also have an optional RF or microwave system to assist in the bonding function. The membrane 1232 can be a Poly Propylene or Poly Ethylene membrane as described before. The release sheet 1233, which is a common sheet of high temperature resistant plastic such as Teflon, functions to prevent damage to the membrane 1232 and to prevent the membrane 1232 from sticking to the top tool 1230. In step “D” two parts 1204 with membrane 1232 are prepared and are positioned in step “E” so that the two membranes on the front side face each other resulting in a plate pair 1234. At the same time an air turbulator 1221 is positioned between the two plates. Step “F” again uses a heat sealing tool around the corner openings 1235 and 1235′. The anti-stick surfaces 1215 now keep the seal open on a small section of the circular seals. This allows desiccant film supports 1222 to be inserted between the film seals and the main carrier plate in step “G” which holds the film seals away from the plate thus forming an unobstructed channel through which the desiccant can flow. The resulting plate stack 1236 from step “G” is created multiple times, usually anywhere from 10 to 80 times. In step “H” a stack is formed using multiple parts 1236 and alternating them with the hot melt coated water turbulators 1228. In step “I” the thus formed assembly receives an edge seal 1238 similar to the edge seal 901/902 in FIG. 9. Finally in step “J” the desiccant film seals are sealed together at the corner locations 1239 similar to the hot tool 903 as shown in FIG. 9.

FIG. 13 shows an “exploded” view of the plate stack 1236 from FIG. 12B. As can be seen in the figure, the assembly comprises (from right to left), a top and bottom film seal 1216, internal film seal supports 1222, an optional glue isolation layer 1301, which functions as a safety seal and is helpful in directing the flow of the heat transfer fluid along the water turbulator and support plate 1228 which as described above is coated with a hot melt adhesive, the main carrier plate 1204, the air turbulator 1221, which is held in place by air seals 1302, which help direct the air flow in a horizontal aspect through the structure, the corner fluid seals 1303, and finally another set of film seal supports 1222 and film seals 1216. This structure is assembled as described above and is built multiple times to create a 10 to 80 structure stack of plates.

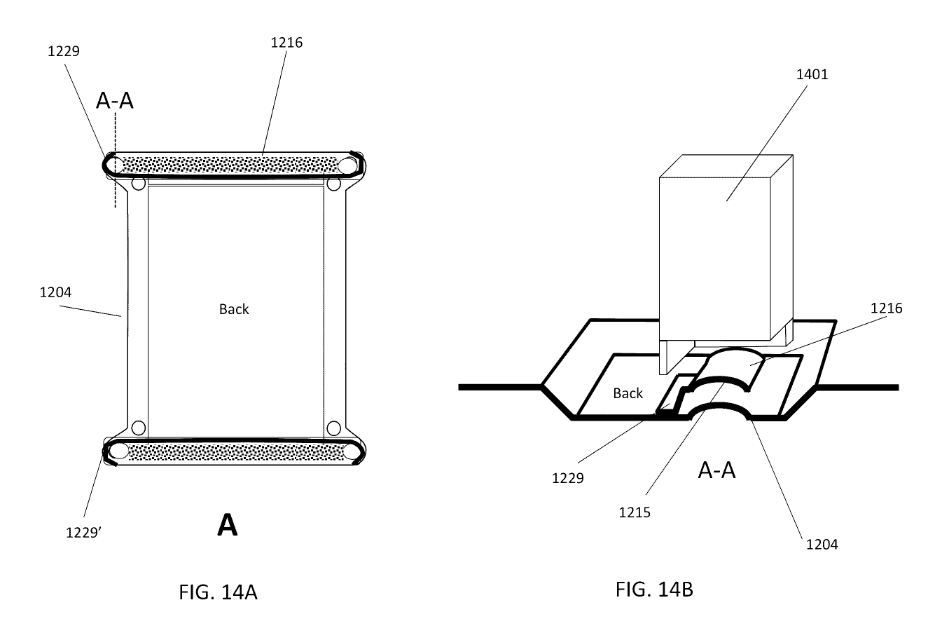

FIG. 14A illustrates at some level of detail how the film seal is attached to the seal 1216 in pattern 1229. Cross section A-A is detailed in FIG. 14B and shows a shaped hot tool 1401 that seals the film seal 1216 to the cap layer on main carrier plate 1204. In areas 1215 where the film seal 1216 is not supposed to stick an anti-stick layer can be applied as described earlier.

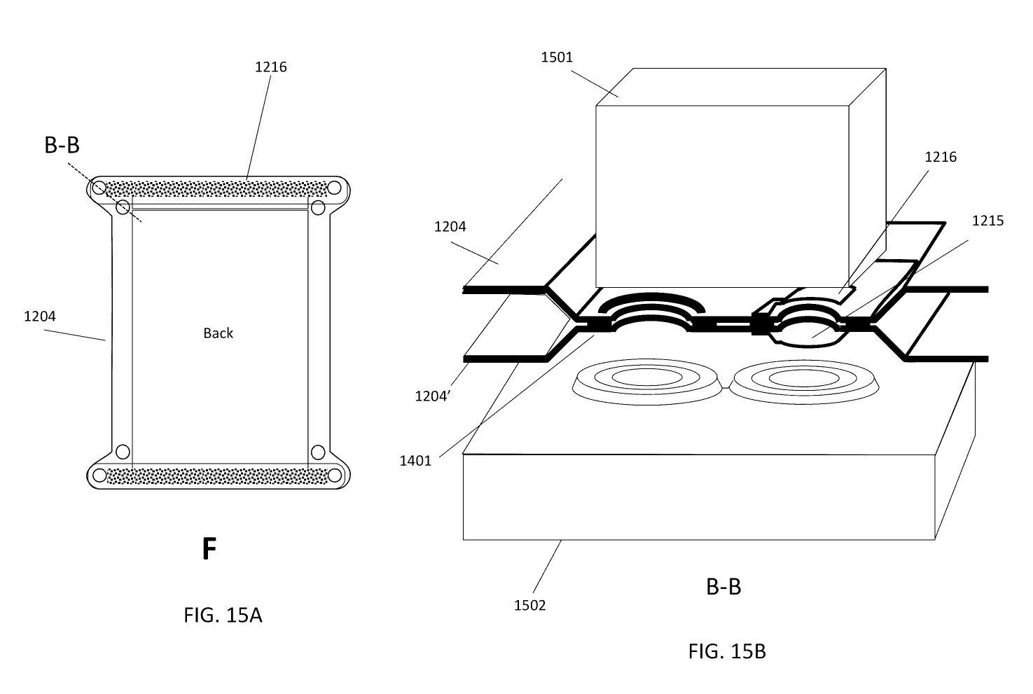

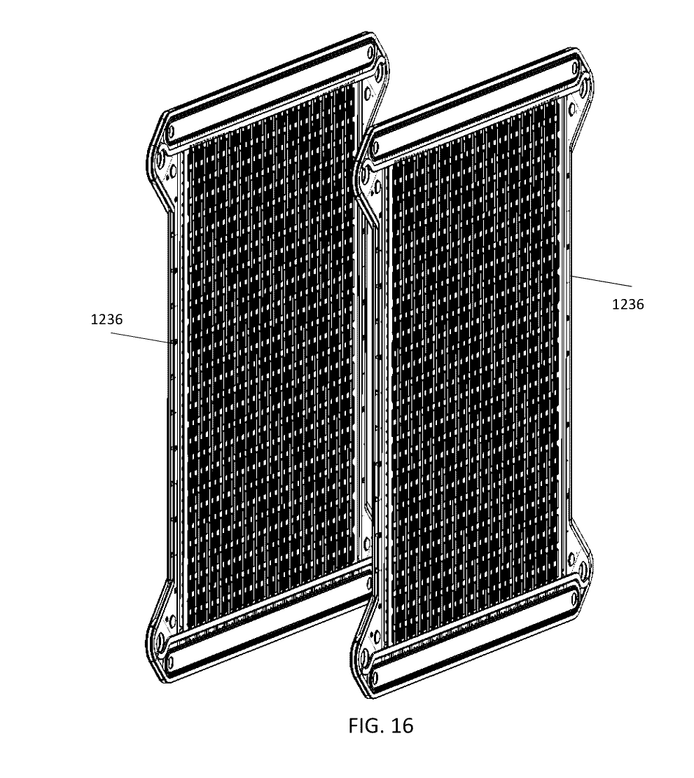

FIG. 15A illustrates a detail on how two main carrier plates 1204 which already have film seals 1216 attached can be bonded together. Tool 1501, which can be heated but can also emit some microwave or radiofrequency heating radiation, is pressed against tool 1502, with the two plates 1204 facing each other. Since main carrier plates 1204 have a cap layer on each side, the film seal is able to be stuck to the rear and the two faces can also be stuck to each other. As mentioned above the anti-stick section 1215 prevents the film seal 1216 from sticking in undesired places.

FIG. 16 shows how two complete assemblies 1236 (from FIG. 12A-12B and FIG. 13), are assembled while the hot melt coating on the water turbulator plates 1228 is still hot, or conversely the hot melt coating can be activated using microwaves or RF in a later stage.

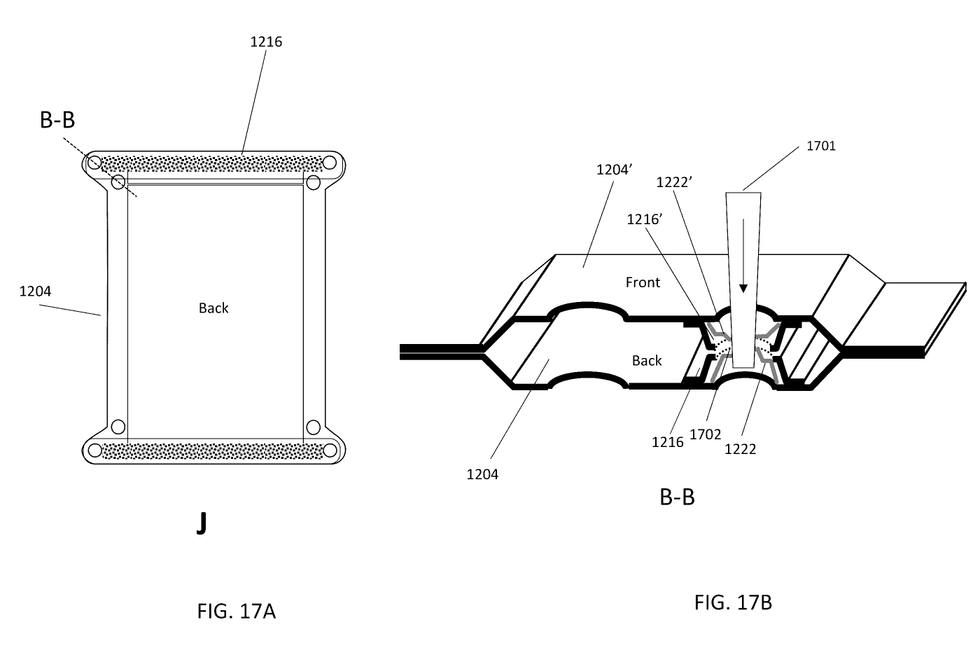

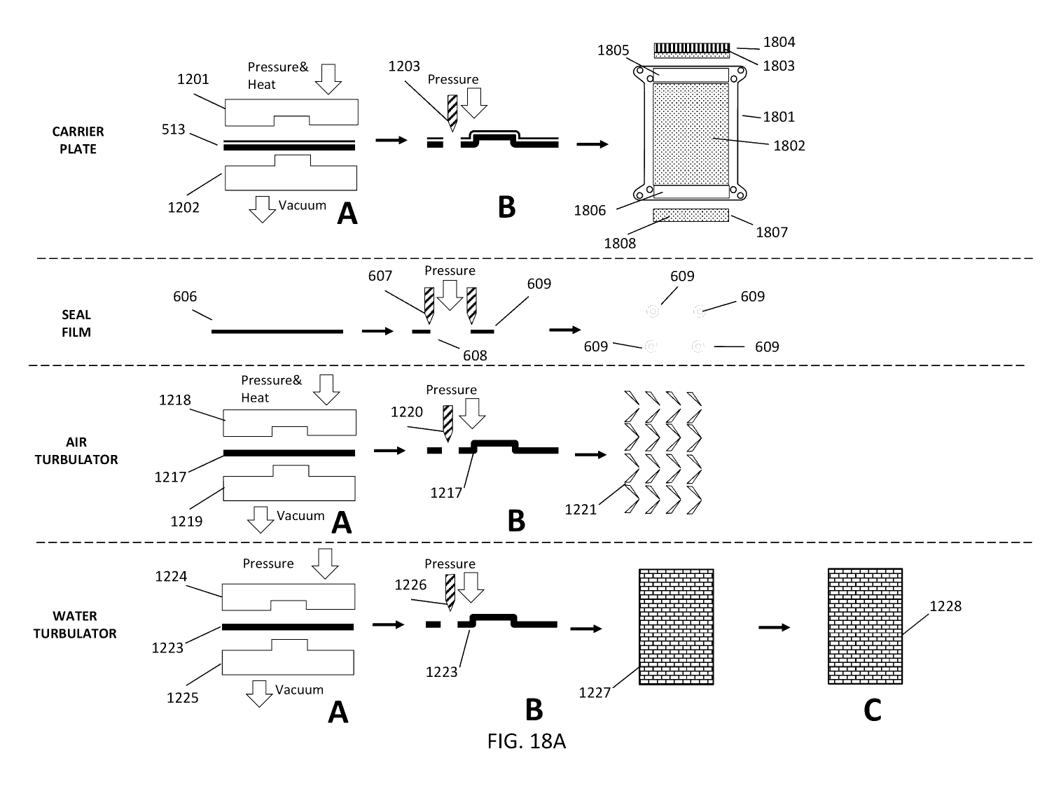

FIG. 17A now illustrates how the stack of plates from FIG. 16 can receive the film seal to film seal. Cross section B-B in FIG. 17B illustrates how the film seal 1216 and opposing film seal 1216′ are sealed together by inserting hot tool 1701 through the openings in the films 1702. Seal support structures 1222 and 1222′ ensure that the film stays in place during the forming of the seal and ensure that there is a passage for the desiccant to flow.

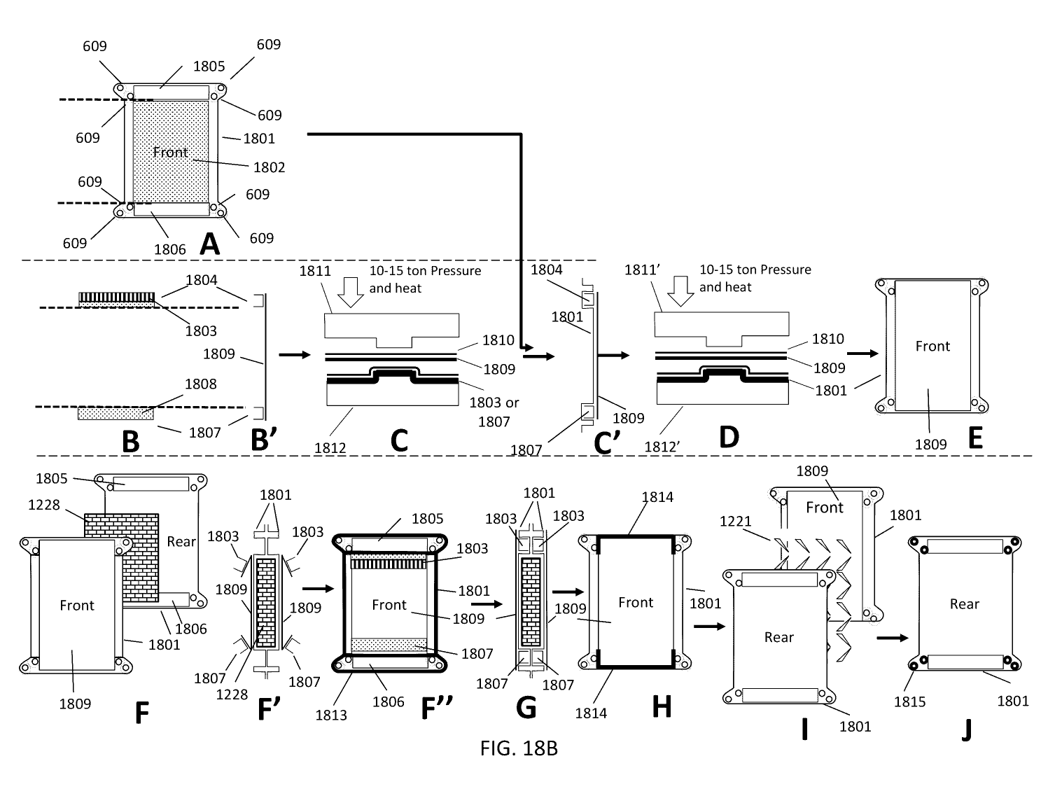

FIG. 18A illustrates an alternate process for accomplishing the same three way air to desiccant to heat transfer fluid heat exchanger plate stack. The carrier material 513 is again thermoformed by tooling 1201 and 1202 and die-cut by tooling 1203. However in this case the carrier material 513 only needs to have a single cap layer which makes it less expensive and more easily available as a standard material from suppliers. The resulting product from this process now contains three distinct components: the main carrier plate 1801 contains a surface 1802 suitable for distributing and bonding the membrane (which will be shown in FIG. 18B). The main carrier plate also contains pockets 1805 and 1806 for receiving components 1804 (which has a properly created surface for desiccant distribution 1807) and 1807 (which has a properly created surface for desiccant collection 1808). Components 1804 and 1807 can be formed in separate thermoforming steps or can be formed alongside the main carrier plate 1801 as is shown here.

Similar to the illustration of FIG. 6, a set of seal film rings 609 can be die-cut from film 606 by die-cutting tool 607, leaving appropriate cut-outs 608. As was shown in FIG. 12A-12B, an air turbulator 1220 can be formed using thermoforming tooling 1218 and 1219 from starting material 1217, which, as discussed earlier, can be made from RPET or a similar material. The die-cutting tool 1220 is used to cut the final part 1221 from the material 1217 as discussed before.

Also in the figure, and similar to FIG. 12A-12B, a water turbulator 1227 is formed from starting material 1223 using tooling 1224, 1225 and die-cutting tool 1226. Again the resulting component 1227 is coated with a hot melt resulting in coated part 1228.

FIG. 18B now illustrates the assembly process of the components formed in FIG. 18A. In step “A” the main carrier plate 1801 receives a number of film seals 609 which can be simply heat bonded to the cap layer on the front of plate 1801. In parallel, in step “B” the desiccant inlet part 1803 and outlet part 1807, are positioned on the membrane 1809. View “B′” illustrates a side view. In step “C” tooling 1811 and 1812 is used to bond the membrane 1809 to the components 1803 or 1807 using release sheet 1810 similar to the process discussed under FIG. 12B. View “C′” shows how the components 1803 and 1807 (which already have the membrane attached) can be “clicked” into part 1801. The resulting assembly is placed in a second set of tooling 1811′ and 1812′ which now bonds the membrane 1809 to the main carrier plate 1801, again using a release sheet 1810. The resulting part is shown in view “E”.

Subsequently two components from step “E” are placed with the hot melt coated water turbulator 1228 as can be seen in view “F”. View “F′” illustrates a cross sectional view, but now we “unclick” the components 1803 and 1807 from the main carrier plates 1801. Since the membrane 1809 is very thin, this material (reinforced with some tape if need be) can be used as a hinge without letting the parts move position and without disrupting the desiccant flow areas 1802, 1804 or 1808. View “F″” now shows that by folding back the components 1803 and 1807, a hot tool can be used to create a proper seal 1813 between the two main carrier plates 1801. View “G” now illustrates a cross sectional view with the components 1803 and 1807 “clicked” back into place. A final seal 1814 is applied in step “H” the seals the edges of the membrane 1809 to the main carrier plates 1801.

Multiple main carrier plate pair assemblies created as described thus far, can now be placed with air turbulators 1221 in-between the plate pairs. Finally in step “J” the film seals are bonded together in corners 1815, similar to the process illustrated in FIG. 17B.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

1. A method of manufacturing a heat exchanger, comprising the steps of:
(a) providing two plates configured to be assembled together, each of said plates comprising a support layer and a cap layer laminated over the support layer at least at a front side of the plate;
(b) heat bonding a microporous membrane layer to one or more select portions of the cap layer on the front side of each plate such that a liquid desiccant channel is formed between the membrane layer and the front side of each plate; and
(c) attaching the front sides of the plates together to form a plate pair structure by heat bonding one or more select portions of the cap layers on the front sides of the plates such that the membrane layers on the plates face each other and an air flow channel is formed between the membrane layers.

2. The method of claim 1, further comprising repeating steps (a) through (c) to produce one or more additional plate pair structures, and then attaching the plate pair structures to each other in a stacked arrangement by bonding outer sides of each plate pair structure to each other such that a heat transfer fluid channel is formed between adjacent plate pair structures.

3. The method of claim 2, further comprising for adjacent plate pair structures:
(i) attaching each membrane layer at one end thereof to a desiccant distribution component and at an opposite end thereof to a desiccant collection component;
(ii) releasably locking the desiccant distribution component and the desiccant collection component to features at opposite ends of the plate;
(iii) heat bonding the membrane layer to one or more select portions of the cap layer on the front side of each plate;
(iv) removing the desiccant distribution component and the desiccant collection component from the features at opposite ends of the plate;
(v) forming a heat transfer fluid seal and liquid desiccant seal between the adjacent plate pair structures; and
(vi) locking the desiccant distribution component and the desiccant collection component to the features at opposite ends of the plate.

4. The method of claim 1, wherein the support layer comprises plastic.

5. The method of claim 1, wherein the support layer comprises Poly Ethylene Terephthalate, Poly Styrene, Acrylonitrile Butadiene Styrene, Poly Carbonate, Poly Vinyl Chloride, or Acrylic.

6. The method of claim 1, wherein the support layer has a thickness of 10-15 mil.

7. The method of claim 1, wherein cap layer comprises a meltable plastic material.

8. The method of claim 1, wherein the cap layer comprises Poly Ethylene or Poly Propylene.

9. The method of claim 1, wherein the cap layer has a thickness of 1-3 mil.

10. The method of claim 1, wherein the membrane layer comprises Poly Propylene, Poly Ethylene, Nylon, or Ethylene ChloroTriFluoroEthylene.

11. The method of claim 1, wherein step (a) comprises
(i) extruding the support layer;
(ii) laminating the cap layer on at least one side of the support layer to form a laminated base material; and
(iii) thermoforming and die-cutting the laminated base material to form the thermoformed plates.

12. The method of claim 1, wherein each of said plates includes liquid ports, and the method further comprises applying a film material on the plates around the liquid ports to form seals around the ports when the plates are attached to each other to form a plate pair structure or when plate pair structures are attached to each other.

13. The method of claim 12, wherein the film seal comprises Poly Ethylene or Poly Propylene.

14. The method of claim 1, further comprising installing an air turbulator between the plates in the air flow channel.

15. The method of claim 1, further comprising installing a heat transfer fluid turbulator between adjacent plate pair structures.

16. The method of claim 1, further comprising installing a liquid desiccant turbulator in each liquid desiccant channel.

17. A heat exchanger manufactured by the method of claim 1.
